(19) United States
(12) Patent Application Publication
(10) Pub. No.: US 2008/0098956 A1
(43) Pub. Date: May 1, 2008

(54) Adjustable paint shield

(76) Inventor: Andras Serfozo, Gainesville, FL (US)

Correspondence Address: Andras Serfozo Sr., 4715 NW 30th St., Gainesville, FL, 32605, US

(21) Appl. No.: 11/900,357

(22) Filed: Sep. 11, 2007

Related U.S. Application Data
(60) Provisional application No. 60/854,521, filed on Oct. 26, 2006.

(51) Int. Cl. B05B 15/04

(52) U.S. Cl. 118/504

(57) ABSTRACT

Present invention is for the use when applying paint by paint-sprayer to cover plane areas X and Y concurrently, in projecting or recessed corner. It is encompassed of two identical semi rigid rectangular panels, said panels are adjustable in numerous angles interrelated to each other. Therefore, its able to protect float up from over spray in corners by utilizing both its internal and external edges. It has a handle that may position in quite a few ways in relation to said panels. The results, present invention is exploitable on floor or on ceiling horizontally and perpendicularly, either exterior or interior use without complexity.

Present invention is not associated with any Governmental Agencies.

### 1. BACKGROUND OF THE INVENTION

The invention is an innovative concept for covering surfaces concurrently of plane X and Y, to avoid paint overspray so to prevent the disadvantages of the common straight shield.

### 2. BRIEF SUMMARY OF THE INVENTION

The main purposes of the present invention are to provide an improved re-useable spray shield that is proficient in protecting from overspray of paint on plane surface, of both projecting corners and recessed corners concurrently of X, Y. Further, to speed up work by eradicating unnecessary waste of time and waste that masking and disposable cardboard shields create. In addition, a new handle design that would protect the user from wrist stress, which is a common problem among straight shield users experience while, pressing their straight shield to gain some angel to cover areas undesired to be over sprayed. Another distinctive advantage of present invention is that it equally can be used on the floor and the ceiling by a fast positioning aptitude of its handle. Further, present invention uniqueness allows the user to myriad angle settings practically instant. Still another advantage of present invention is that although its primary method of use is to protect plane surface of X and Y simultaneously, it is adjustable to utilize as a common straight shield too.

### 3. BRIEF DESCRIPTION OF THE SEVERAL VIEW OF DRAWING

According to the submitted drawings;

### Page 1 of 11

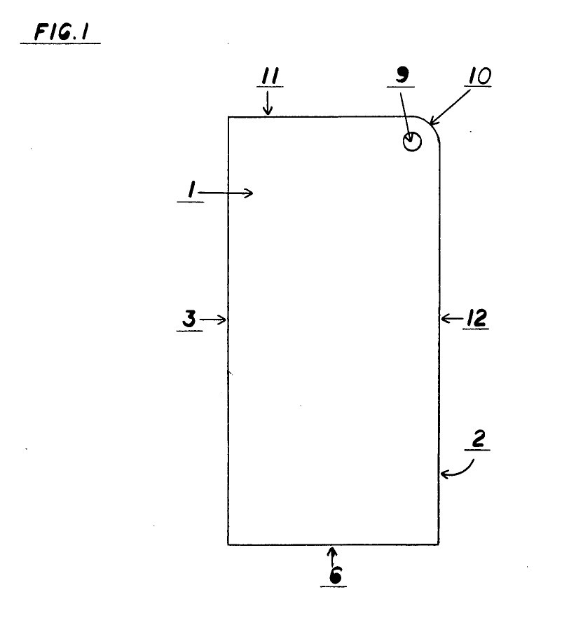

FIG. 1 shows an individual rectangular panel for explanation of future numbering references. The starting position is correct when the panels' trough hole (9) is on the upper right corner. The panel has, Front (1)-Back (2), Top edge (11),-Bottom edge (6), Right edge (12)-Left edge (3), also a Trough hole (9), and the Panels' Arc (10).

### Page 2 of 11

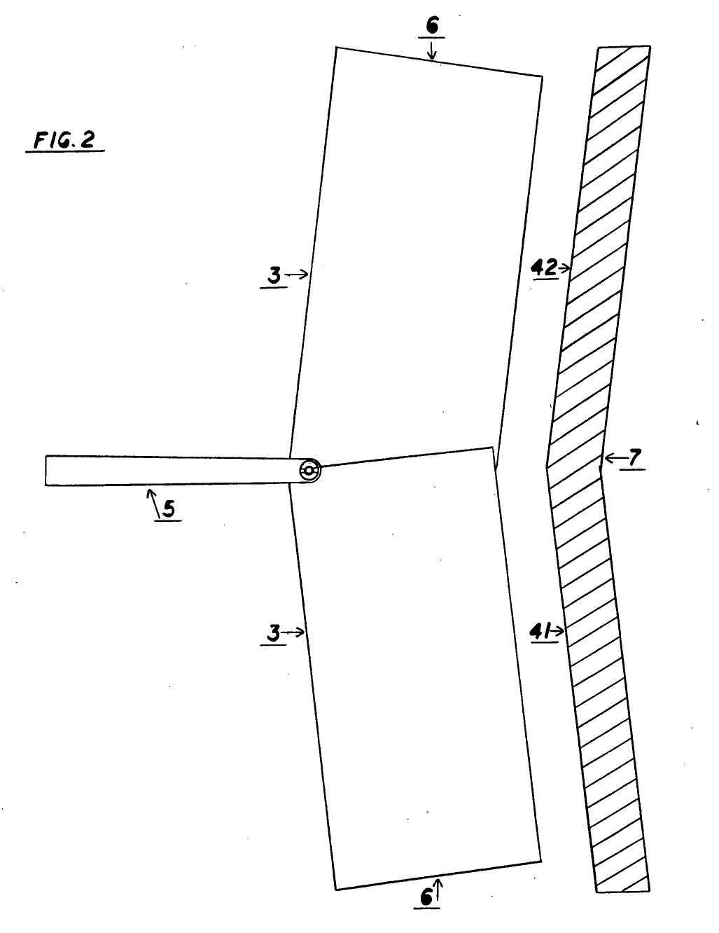

FIG. 2 is designed for a “Front Page View” illustrates the assembled shield from top view in use at a building structure's wall (7), comprised of two rectangular pieces exhibit the shield is positioned to some degrees concurrently of X, Y, that its outside edges follow and cover the floor in a projecting corner of wall (41, 42). In addition, it shows the handle (5) is set to outside position as well as the shield panel's bottom edges (6), and outside edges (3).

### Page 3 of 11

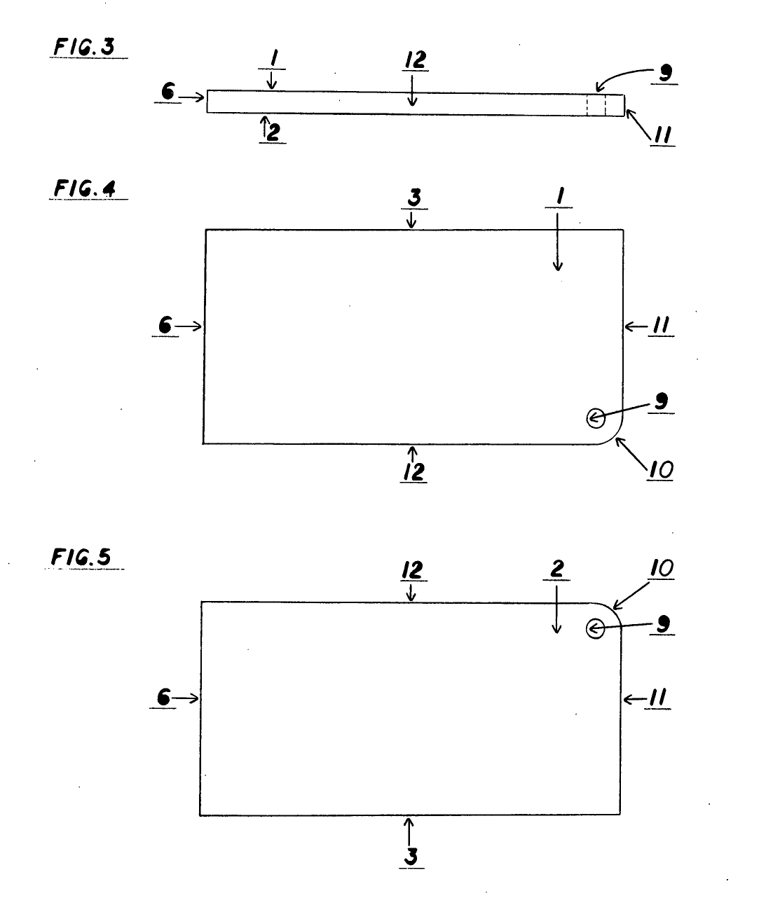

FIG. 3 shows the shield in side view its Front (1), Back (2), Right edge (12), and a trough hole (9), Top (11), Bottom (6), the component scope can be of variable size.

FIG. 4 shows the rectangular shield from top view having a Front (1), Top (11), Bottom (6), Left (3), and Right (12), sides, in addition shown is a trough hole (9), and Arc (10).

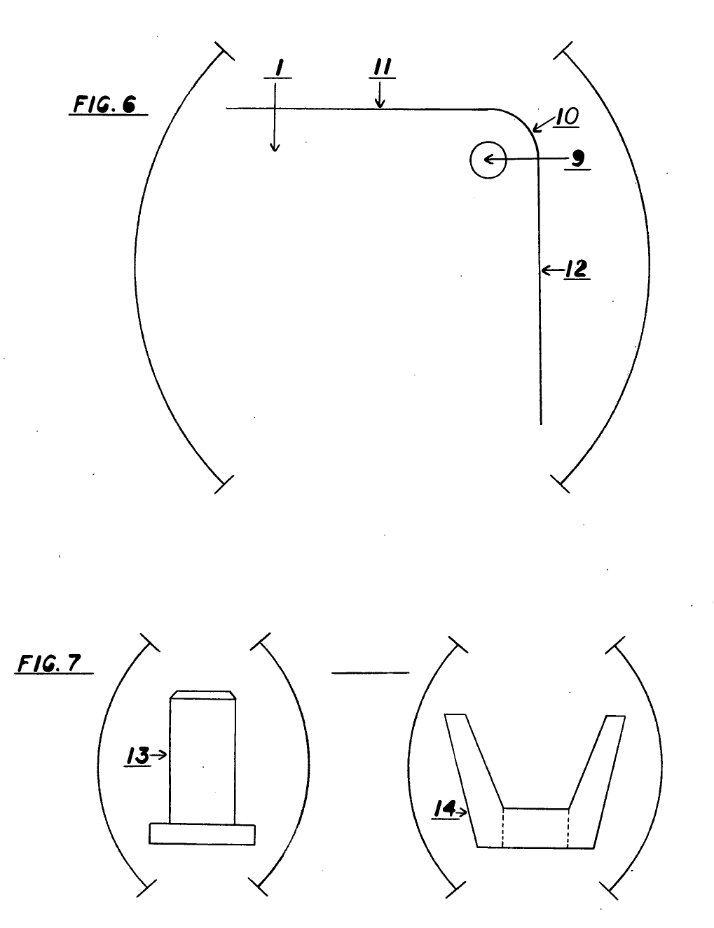

FIG. 5 shows the rectangular shield from bottom view having a Back (2), Top (11), Bottom (6), Left (3), and Right (12) sides, in addition shown is a through hole (9), and Arc (10).

### Page 4 of 11

FIG. 6 is an exploded view in brackets; one of the shield panels' upper right corner shows a trough hole (9), and the Arc (I 0), in addition to its Top (11), Right side (12) and Front (1).

FIG. 7 is exploded view in brackets; of the fasteners a Bolt (13), and a Wing nut (14) they are without specific size, shape, and tread.

### Page 5 of 11

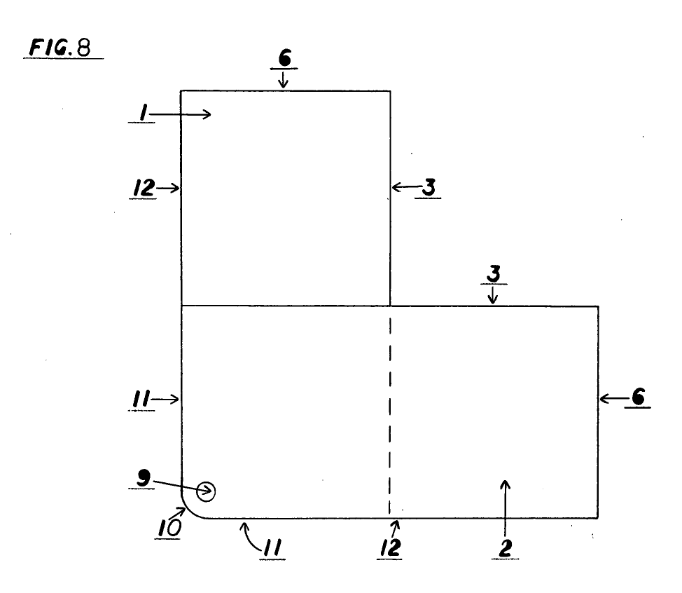

FIG. 8 shows the shield assembled in some angle. The identical panels' holes (9) have to line up one of the panel located on the top with its Back (2) facing up and the Top (11) and Right (12) edges facing out-ward. Whereas the corresponding panel is turn over and located underneath with its Front (1) facing up and the Top (11) and Right (12), edges facing out-ward. In this arrangement, shows that the inner edges (3) and the outer edges (12) equally can be exploited in projecting corners or recessed corners regarding of the handle relationship to the panels that is either inward or outward position. In addition, the panel's arc (10) also shown.

### Page 6 of 11

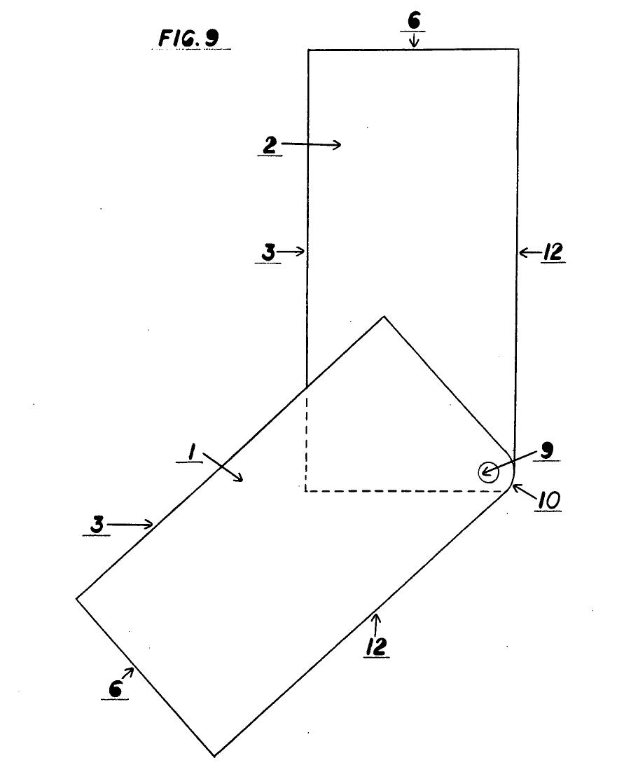

FIG. 9 shows the shield is assembled in a different angle. The identical panels' holes (9) have to line up one of the panel located on the top with its Front (1) facing up and the Right (12), and Bottom (6) edges facing out-ward. Whereas, the corresponding panel is turned over and located underneath with its Back (2) facing up and the Right (12) and Bottom (6) edges facing outward. This arrangement shows that the inner edges (3) and the outer edges (12) equally can be exploited to projecting corners or recessed corners regarding of the handle relationship to the panels that is either inward or outward position. In addition, the panel's arc (10) also shown.

### Page 7 of 11

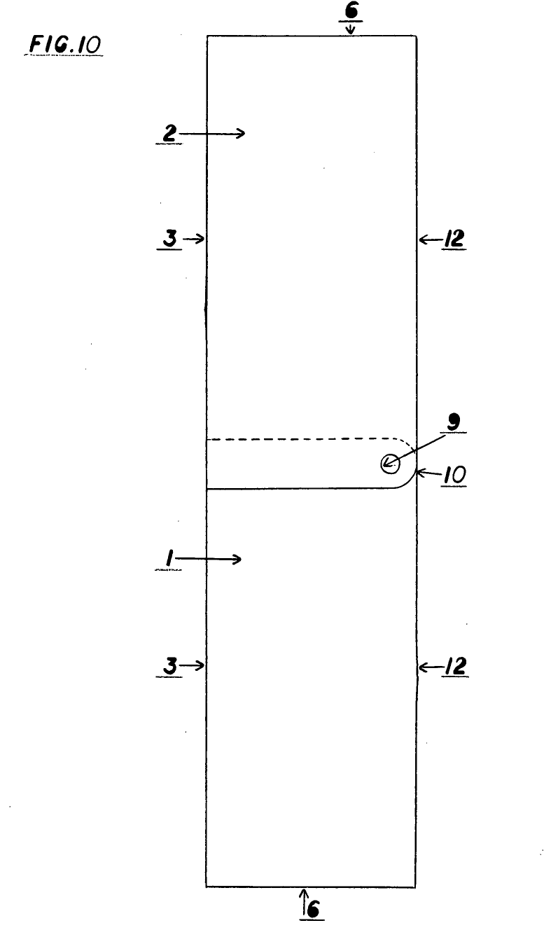

FIG. 10 shows the method of the shield panels assembled in a straight line. One panel of the shield Backside (2) on the top whereas underneath the other panel Front side (1) on top. In addition it shows that both (3), and the (12), side edges together can be exploitable depending on the handle affiliation to the panels. Also shown the bottom edges (6).

### Page 8 of 11

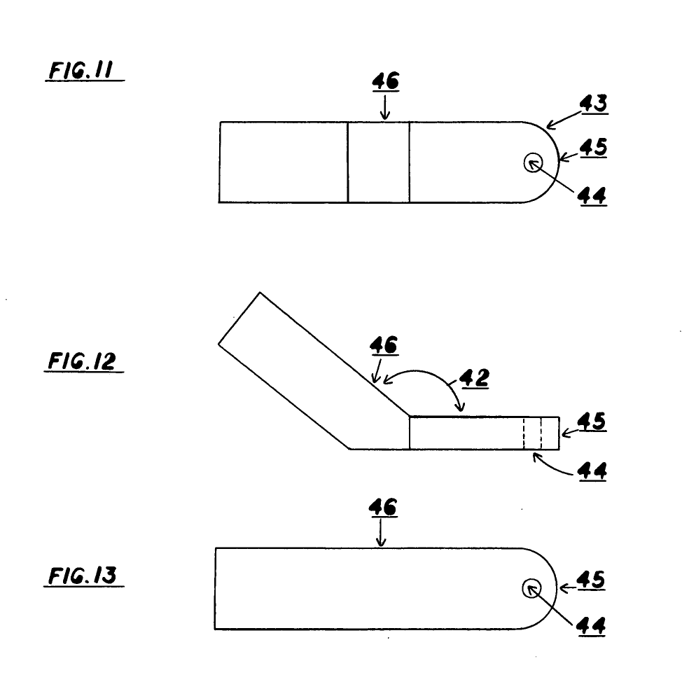

FIG. 11 shows the handle tips' in a Top view, trough hole (44), the Arc (45), and the nose section (43), as well as the extension section of the handle (46) which can be of variable length.

FIG. 12 shows the side views of the handle tip the angle bend (42) for convenient handling and the extension section (46) both can be of variable length. Also shown through hole (44), and the Arc (45).

FIG. 13 shows a top view of the handle and its tip the trough hole (44) and the Arc (45) the handles' length (46) may be variable.

### Page 9 of 11

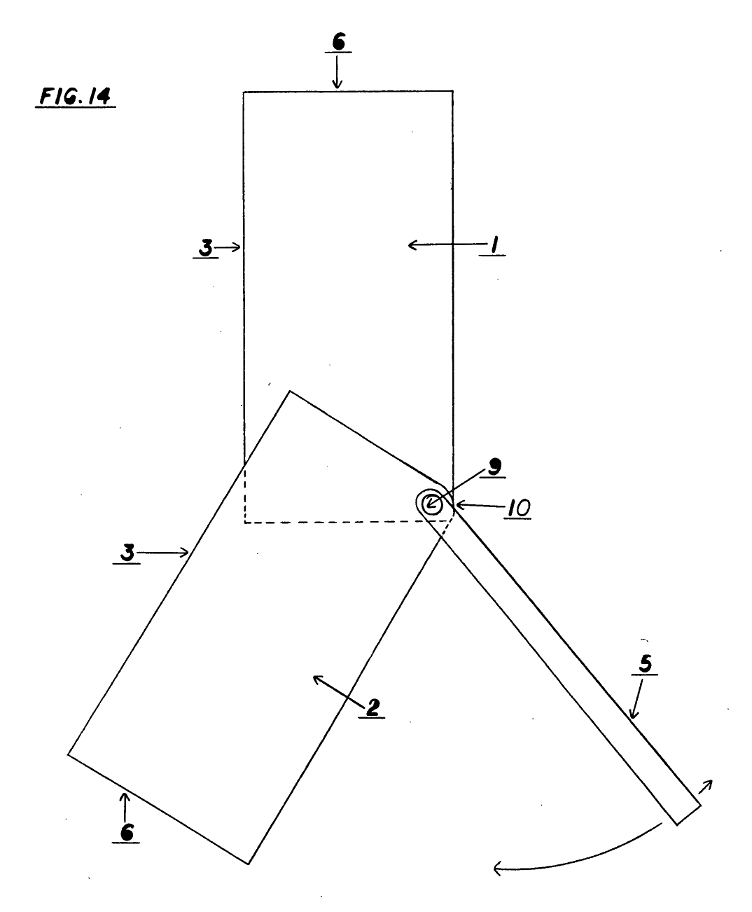

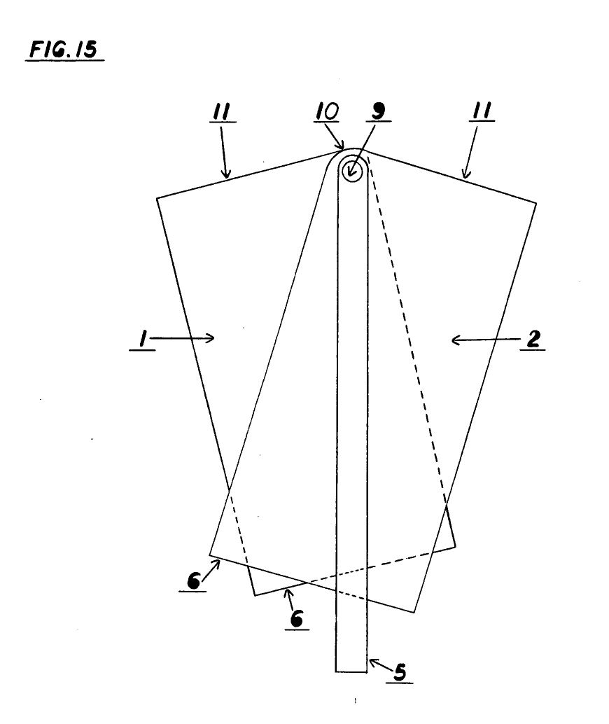

FIG. 14 shows a top view of the shield panels (1), (2), assembled in some angle with the handle (5), through hole (9), arc (10), bottom edges (6), left edges (3), and it is illustrates that the handle can be rotate above and around the panels in either direction of 360 degrees compliant with the task requirement.

### Page 10 of 11

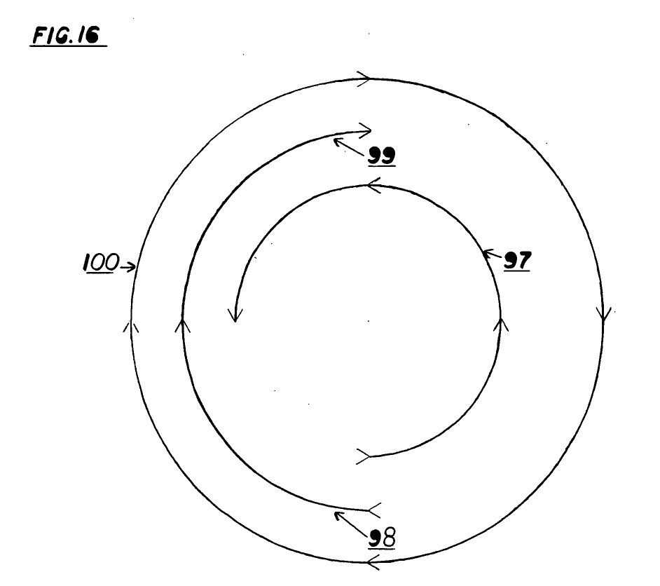

FIG. 15 shows the shield panels (1), (2), in closed positions and its handle (5), is arranged inward position as of a result an obtainable and functional top short edge (11) exists. In addition through hole (9), arc (10), bottom edges (6) shown.

### Page 11 of 11

FIG. 16 shows a geometrical circle and illustrate the actual angles that the shield panels, along with its handle, are capable of attaining. The handle (100) is circle 360 degrees in any direction, the shields' inner edges (98), (99), from 90 to 180 degrees, and the shields' outside edges (97) from 180 to 270 degrees.

### 4. DETAILED DESCRIPTION OF THE INVENTION

Conventional straight paint shields are a popular tool among professional painters, predominantly to those who utilize a technique to applying paint by paint-sprayer, spray can or similar spray device. In spite of its popularity, conventional solid straight shield always had a disadvantage, when it has to protect areas concurrently of X and Y plane surfaces. Some examples include protecting floor at the entrance corner, shielding the ceiling while spraying walls at the neighboring bend, or guard the walls while spraying the frames of window and door as well as to protect from overspray on the wall around a cabinet or alike object. This failure is present since by nature solid straight shields are made of one piece and consequently protects only in straight line either of X or Y plane, but never simultaneously. In recognition of said insufficiency with the new adjustable shield, such problems finally are abolished without difficulty. Present invention consists of two rectangular sheets that could be arranged in numberless angles, in reference to its positioning, its' internal and external edges hugs bends and corners. This uniqueness allows to using present invention equally in horizontal or perpendicular plane surfaces.

Previously quite a few inventors designed shields such as;

Hendrick, U.S. Pat. No. 2,290,472 Date: Jul. 21, 1942 Discloses; Painter masking shield.

### Current U.S. Class: 118/505

### Current International Class: B05B 15/04 (20060101)

Eckart Jr. U.S. Pat. No. 3,863,601 Date: Feb. 4, 1975 Discloses; Surface masking device for painters.

### Current U.S. Class: 118/505; 118/504; 427/282

### Current International Class: B05B 15/04 (20060101); B05c 011/16 ( )

### Field of Search: 49/404,414 118/504,505 117/8.5,38 161/167

Stark, U.S. Pat. No. 4,331,716 Date: May 25, 1985 Discloses; Spray shield and spraying method.

### Current U.S. Class: 427/282; 118/504; 118/505; 427/284; 427/427.7

### Current International Class: B05B 15/04 (20060101); B05D 1/02 (20060101); B05D 1/32 (20060101); B05D 001/02 ( )

### Field of Search: 33/415,416,421,481,457,459,482 15/248R 51/268,270,272,274,310 52/58,62 118/504,505 427/421,282,284,345

McAlister, U.S. Pat. No. 3,942,472 Date: Mar. 9, 1976 Discloses; Painting guide apparatus.

### Current U.S. Class: 118/504

### Current International Class: B05B 15/04 (20060101); BOSC 011/00 ( )

### Field of Search: 118/505,504,301

McClane, U.S. Pat. No. 4,248,914 Date: Feb. 3, 1981 Discloses; Method of utilizing a flexible paint shield.

### Current U.S. Class: 427/282; 118/504

### Current International Class: B05B 15/04 (20060101); B05D 1/32 (20060101); B05B 015/04 ( ); B05D 001/02 ( )

### Field of Search: 118/504,301,505 427/282,272

Harris Jr. U.S. Pat. No. 4,398,495 Date: Aug. 16, 1983 Discloses; Paint Shield.

### Current U.S. Class: 118/504; 118/505; 428/121; 428/130; 428/131; 428/152; 428/156

Current International Class: B05B 15/04 (20060101); B05C 011/00 ( )

### Field of Search: 428/542.8,131,130,121,156,157 118/504,505,301 156/257,258

Stevens, at al. U.S. Pat. No. 4,574,731 Date: Mar. 11, 1986 Discloses; Disposable spray shield.

### Current U.S. Class: 118/504

### Current International Class: B05B 15/04 (20060101); B05C 011/00 ( )

### Field of Search: 118/504 29/4B

Brubaker U.S. Pat. No. 4,235,192 Date: Nov. 25, 1980 Discloses; Corner painting shield.

### Current U.S. Class: 118/504

### Current International Class: B05B 15/04 (20060101); B05C 011/00 ( )

### Field of Search: 118/504,505 427/272,282 15/257R,26R,262.1,274,310

Thompson U.S. Pat. No. 4,962,722 Date: Oct. 16, 1990 Discloses; Adjustable protection shield for preventing coating overspray on a building's surface.

### Current U.S. Class: 118/504

### Current International Class: B05B 15/04 (20060101); B05C 021/00 ( )

### Field of Search: 118/504,505,301 427/282 29/402.18 248/111

Long, et al. U.S. Pat. No. 5,103,762 Date: Apr. 14, 1992 Discloses; Spray paint shield.

### Current U.S. Class: 118/504; 428/120

### Current International Class: BO5B 15/04 (20060101); B05C 011/00 ( ); B05C 021/00 ( )

### Field of Search: 428/119,120 118/504,505

Foreign Patent Documents;

### GB. 581704 Date: April 1944

### GB. 1400406 Date: July 1975

With all do respect to above listed prior inventions, while they possess the meaning for their individual purposes, none of them functions and is capable to solve the main problem, covering plane surface of X and Y, at the same time with one move in corner areas that exists in every day architectural home design. The present invention is a multipurpose tool proficient of performing a variety of tasks. It comprise of two identical rectangular panels that are functioning as an adjustable shield. The panel's size and thickness can be variable. These mobile panels make the present invention a distinct tool. Further, a newly designed handle and its position associated to said panels are imperative, whereby the present invention can be equally exploitable on the floor or on the ceiling. The use of present invention is very simple and does not require learning any new skill from a person having ordinary ability in the field of painting and shielding. Matching up to other shields it is easily recognizable that the present invention is a universal tool having the merit to exploit in a previously inconceivable way. The advantage of present invention above any other shields is the distinctive aptitude when it comes to protecting multiple plane-angled areas simultaneously. When present invention handle is set in outward position related to the shield panels, it can cover surface on floor in quiet a few angles. When said handle is set in inward position related to the shield panels, it can cover surfaces besides the floor, in corner of the wall and ceiling, door and window returns or other similar objects perpendicularly and horizontally. In addition, next to its principle purpose to protect simultaneously in X and Y planes, by loosing the fasteners, the shield panels can be set in a fully opened position so it is exploitable effortlessly as a common straight shield. Therefore present invention distinctly differentiates itself fundamentally from prior art. The present invention can be manufactured from any currently used materials that common straight shield are composed of, therefore is just as easy to clean. It is re-useable and by folding it in half, can be stored up fluently. Another advantage of present invention is in its unique bended handle design whereby one can use it without pressing it to gain some slant of the panels as a well-known practice with straight shield causing premature break of the shield and heavy wrist stress.

Slight alteration falling within the aptitude and spirit of present invention will occur to those skilled in the art. The paint shield, hence, is not to be contemplated of as limited to the exact embodiment disclosed here merely for illustration purposes.

We claim:

1. Adjustable Paint Shield with adjustable panels and method to pre-arrange in a variety of angles to protect plane surfaces of X and Y concurrently from over spray comprise of;
a) Two indistinguishable semi rigid rectangular panels each has front, back, top, bottom, left, and right side said panels curved and having hole near on its right top side. Said curves' exactly follow the drilled hole arc. Said holes geometrical center located not less than 1/16^{th} of an inch and not more than 2 inch from the top and right side edges of the panels. The size of the hole and the thickness of said rectangular panels could be variable.
b) A handle that precisely arc and contain hole on one end as identical as on said panels. Further said handle is flattened approximately 2 inch long on the drilled side and bended in some degrees for convenient use. Said handle length, width, and shape could be variable.
c) In addition, bolt and wing nut for fastening said panels and handle jointly in the preferred position.
d) Assembling said panels; said holes must be lined up, one of the said panel located on the top with its back side up and its top and right edge facing out-ward, while the other located underneath with its front side up and its top and right edge facing out-ward.

2. Adjustable Paint Shield having movable rectangular panels and its handle can position so it can equally exploitable on the floor or on the ceiling to protect plane surface X and Y concurrently, perpendicularly and horizontally. An arrangement of said handle relating to said panels whereas in external position it functions on floor in any angles between 40 to 180 degrees. A different arrangement of said handle is in internal position relating to said panels; as a result, it is useable in addition on the floor as well on the ceiling in any angles between 90 to 180 degrees. Further, the fasteners in use do not need to be taken apart to attain the right settings, rather loosen sufficiently to swing the panels and handles into the desired position.
a) The alignment of said rectangular panels in 180 degrees and its handle regardless of its position relating to said panels is to protect surface as a straight shield.

3. Adjustable Paint Shield having moveable rectangular panels;
(a) When said shields handle is set to inward position related to said panels the angles ranges between 180 to 270 degrees to protect surfaces and uses the outside edge of the shield touching and aligned with the object.
(b) When said shields handle is set to outward position related to said panels the angles ranges between 40 to 180 degrees to protect surfaces and uses the inside edge of the shield touching and aligned with the object.
(c) A method to use the short top outside edge of said shield while the handle is set to inward position and the shield inside angle is set between 0 to 70 degrees obtainable top short outside edges exists between 210 to 250 degrees.
